(19) United States
(12) Patent Application Publication
(10) Pub. No.: US 2018/0203604 A1
(43) Pub. Date: Jul. 19, 2018

(54) FAST ARCHIVAL WITH LOOPBACK

(71) Applicant: CISCO TECHNOLOGY, INC., San Jose, CA (US)

(72) Inventors: Rohit Bahl, Kanata (CA); Stephen Joseph Williams, Stittsville (CA); Harshavardhan Parandekar, San Jose, CA (US)

(73) Assignee: CISCO TECHNOLOGY, INC., San Jose, CA (US)

(21) Appl. No.: 15/410,613

(22) Filed: Jan. 19, 2017

(51) Int. Cl. G06F 3/06; H04L 29/08

(52) U.S. Cl. CPC G06F 3/061; H04L 67/1097; G06F 3/067; G06F 3/0647; H04L 67/2819

(57) ABSTRACT

In one embodiment, an accelerator node transfers a first fragment of the data in a first format received from a data generating machine to a storage node. The accelerator node reads the first fragment in the first format from the storage node after the transferring is complete. The accelerator node transforms the accelerator node the first fragment in the first format to a second format. The accelerator node writes the first fragment in the second format by the accelerator node to the storage node.

### TECHNICAL FIELD

This disclosure relates in general to the field of computing, data storage and archival, more particularly, to providing fast archival of data with loopback.

### BACKGROUND

Computing machines generate vast amounts of productive data that often need to be preserved. The productive data can be as large as many gigabytes or terabytes. The productive data can include build trees from development teams, media such as video and audio files, databases, digital assets, collection of files and/or documents, data to be backed up to a server, disk images, data and/or files associated with application(s), etc. To archive the data, the data has to be moved off the computing machine that generated the data to an end storage location for archival. Unfortunately, many utilities for moving the data and archiving data of many gigabytes can take hours, which can be too slow.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 shows a distributed system for fast archival of data with loopback, according to some embodiments of the disclosure;

FIG. 2 shows a system for provisioning accelerator nodes, according to some embodiments of the disclosure;

FIG. 3 shows an exemplary messaging flow for provisioning accelerator nodes, according to some embodiments of the disclosure;

FIG. 4 shows a system for executing archival, according to some embodiments of the disclosure; and

FIG. 5 shows a system for executing archival, according to some embodiments of the disclosure.

### DETAILED DESCRIPTION OF EXAMPLE EMBODIMENTS

### Overview

In one embodiment, an accelerator node transfers a first fragment of the data in a first format received from a data generating machine to a storage node. The accelerator node reads the first fragment in the first format from the storage node after the transferring is complete. The accelerator node transforms the accelerator node the first fragment in the first format to a second format. The accelerator node writes the first fragment in the second format by the accelerator node to the storage node.

### Example Embodiments

Understanding Archival Speeds

Archival of data means moving data generated by and from computing machine, referred to herein as “a data generator machine” to an end storage location, referred herein broadly as “a storage node”. In some cases, the storage node is a (dedicated) storage filer belonging to the Network-Attached Storage (NAS) category. A NAS storage filer can be a file-level computer data storage server communicably connected to a computer network. The NAS storage filer allows access to the files stored on the storage filer over the network, and are often used for data archival. The data transfer between the two end points associated with archival of data, i.e., from the source data generating machine to the target storage node can generally take an exorbitant amount of time and can clog up computing and network resources. The large delay of transfer completion time meant that the data generating machines (e.g., the compute powerhouses) would end up being tied up longer, decreasing build throughput, and preventing sanctioned builds from being available to the developer community sooner. It would be beneficial to reduce the completion time of data archival.

One exemplary scenario involves a build/release engineering team having to archive build trees exceeding half a terabyte in size to dedicated storage nodes (e.g., NetApp dedicated filers). One way to archive the data may include first mounting the NAS as a Network File System (NFS) drive, then copying the data over to the NAS using utilities or tools such as UNIX cp, UNIX cpio, UNIX scp ACME COPY, and rsync, to copy and move from one system to another system. In one experiment, a file having more than 300 gigabytes can take more than 12 hours to archive, holding up the data generating machine for an extended period of time. It is preferable to reduce the time to less than an hour for such an example. Another way to archive the data is to use an “archive as a service” solution, which bandages together UNIX utilities and representational state transfer (REST) based application programming interfaces (API). While an interface is available, the utilities and tools being used behind the interfaces to copy and move files remain slow.

Counter-Intuitive Solution: Loopback

Some solutions aim to improve speed by making the moving of the data more direct, e.g., reducing network distance between the source data generating machine and the target storage node, to decrease the amount of time needed for copy and moving data. However, to archive large amounts of data (more than a terabyte), the transfer can still hold up both the data generating machine and the target storage node for a long time, i.e., the data generating machine would be busy for hours until the transfer is completed. To address this issue, the present disclosure describes a system that does not attempt to transfer the data to a node that is closest to the source data generating machine, which can seem counter-intuitive. The system involves an archival service that finds distributed accelerator nodes which are closer or co-located with the target storage node. This is different from other solutions which aim to minimize the network distance between the source data generating machine and the target storage node. Furthermore, the system implements a loopback mechanism, which means that the data is transferred to the target storage node by accelerator nodes, only to be read back to respective accelerator nodes. The accelerator nodes would perform any necessary transformations, and replace the data that was previously written to the target storage node. The loopback mechanism can theoretically increase the overall network distance traveled by the data in the overall scheme (which is counter-intuitive). However, the loopback mechanism can actually provide several advantages. First, by looping back to perform necessary transformations after the transfer is complete, the source data generating machine can be freed up sooner, i.e., once the transfers from the source data generating machine to the accelerator nodes are complete without having to wait for the transformations to be completed. Second, by breaking up the overall archival process into multiple parts and processes, the overall system can be more fault tolerant. Various details and advantages are outlined later in this disclosure.

With loopback, the fast archival system aims to perform the transfer first, and transformation later. The resulting archival system is thus limited not so much by the transfer of data between the source data generating machine and the accelerator node or the transfer of data between the source data generating machine and the target storage node. The resulting archival system is more limited by how close the accelerator node is to the target storage node (e.g., number of network hops or speed of communication between the accelerator node and the target storage node) due to the loopback mechanism involved. It is thus preferred that the accelerator nodes are co-located or close to the target storage node. Also, the resulting archival system is able to ultimately reduce the amount of time that the data generating machine is held up (i.e., busy) when archiving a large amount of data. Without the loopback mechanism, a direct transfer between two nodes transferring several terabytes of data and transforming the terabytes of data can require a lot of memory resources of both nodes, and the memory resources are held hostage until the transfer and transformation(s) are complete. With the loopback mechanism, the memory resources only needs to be available as long as the transfer of data has reached the destination storage node, without having to wait for the transformations to be complete. In other words, once the data has been transferred to target storage node, the data generating machine is free to perform other tasks (without having to wait for necessary transformations to complete).

Exemplary “Archive as a Service” System

In some embodiments, an exemplary system offers archival as a service, which enlists the help of multiple accelerator nodes to transfer and transform data for archival. Transfers can occur concurrently or in parallel. Transformations can also occur concurrently or in parallel. In addition to speeding up archival, the architecture and processes helps ensure efficient re-transmission of only limited data in a lossy network. As used herein, archival or the archival process involves transferring of data and one or more necessary transformations on the data to make the data being transferred usable.

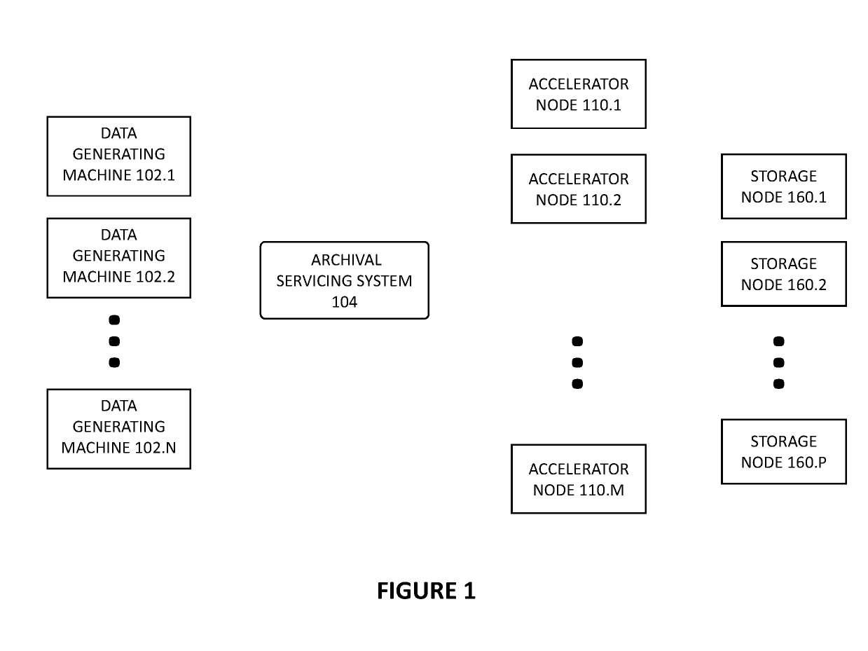

FIG. 1 shows a distributed system for fast archival of data with loopback, according to some embodiments of the disclosure. The system can include one or more data generating machines 102.1, 102.2 . . . 102.N. For simplicity, the examples herein will refer to just one data generating machine 102.1, and are not intended to be limiting to the scope of the disclosure. The data generating machines are source nodes or source machines which generates data to be archived by the system. The data to be archived can be in the order of gigabytes and terabytes.

The system can also include an archival servicing system 104, which serves the role for providing archival as a service. The archival servicing system 104 provisions accelerator nodes for a particular archival job, and may even provision the target storage node. The archival servicing system 104 can implement a REST-based “Archive as a service” (AaaS) interface, hosted on a cloud platform. The archival servicing system 104 can manage resources being used by various archival jobs and also determine optimal provisioning of accelerator nodes and target storage node. For transferring a large amount of data, one or more ones of the accelerator nodes 110.1, 110.2, . . . 110.M and one or more ones of the storage nodes 160.1, 160.2, . . . 160.P (e.g., a partition on one or more ones of the storage nodes 160.1, 160.2, . . . 160.P), may be provisioned or chosen for a particular archival job by the archival servicing system 104. The archival servicing system 104 interfaces with agents or clients on data generating machines, maintain information about accelerator nodes 110.1, 110.2, . . . 110.M and storage nodes 160.1, 160.2, . . . 160.P, and processes archival job requests from the agents or clients. Processing of archival job requests involves provisioning the accelerator nodes (including initiating processes on the accelerator nodes) and possibly also provisioning the target storage node. Generally speaking, the archival servicing system 104 is not involved in the actual execution of the archival process (i.e., the archival servicing system does not execute data transfers or transformations on the data).

Once the archival servicing system 104 has provisioned the accelerator nodes and the target storage node, the data generating machine can execute the archival job. Archiving by the data generating machine includes fragmenting the data into fragments (or parts). For instance, if a build tree (i.e., the data) is to be archived, a fragment of the build tree can be a file. The data generating machine transmits fragments of the data (in some cases, concurrently) to the one or more and provisioned accelerator nodes, e.g., in an archive format or compression format, via a direct communication channel between the data generating machine and a given provisioned accelerator node. A low overhead protocol can be used for the direct communication channel. Note that the fragments are not transferred through a cloud archival service which obfuscates the processes within it. Rather, the data generating machine transfers fragments directly to provisioned accelerator nodes, which in turn transfer the fragments directly to the target storage node. The one or more provisioned accelerator nodes receiving the fragments then transfers the fragments to the target storage node, via a separate direct communication channel (e.g., stream) between the accelerator node and the target storage node. The separate channel makes the overall archival process more fault tolerant, in particular, to faults in the data generating machine, the accelerator node, and in the link between the data generating machine and the accelerator node. Once fragments are successfully transferred to the target storage node, the one or more provisioned accelerator nodes begins the loopback mechanism for each fragment. The archive or compression format is typically unusable or illegible, since such formats typically compresses data. The one or more provisioned accelerator nodes reads the fragment in the archive or compression format from the target storage node, performs one or more necessary transformations (e.g., unpack, decompress, decrypt, etc.) to obtain the fragment in its original format, and writes the fragment in its original format to the target storage node. The loopback can replace the fragment on the target storage node with the fragment that is in its original format. The original format would make the data usable or legible.

The system shown includes one or more accelerator nodes 110.1, 110.2, . . . 110.M and one or more ones of the storage nodes 160.1, 160.2, . . . 160.P. The accelerator nodes are preferably co-located with the target storage node. An archival job may use one or more accelerator nodes. An accelerator node can process one or more fragments for a given archival job, i.e., transfer one or more fragments and perform one or more transformations for the one or more fragments as part of the loopback mechanism.

For simplicity, examples herein are described with respect to one archival job using two accelerator nodes and one target storage node. These examples are not intended to be limiting to the scope of the disclosure. Functionalities, modules, and processes within these parts of the distributed system are described in greater detail, alongside an exemplary archival job. Various parts and components shown in FIG. 1 can be communicably connected with each other, e.g., over a communication network, to cooperate and perform the various functions and processes described herein.

Provisioning Accelerator Nodes

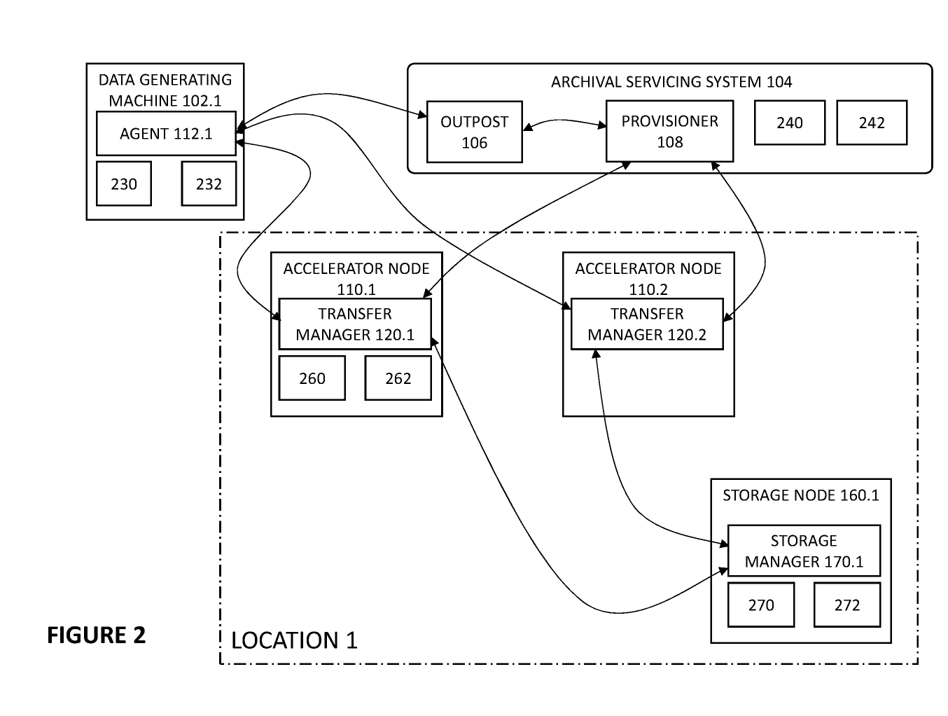

FIG. 2 shows a system for provisioning accelerator nodes, according to some embodiments of the disclosure. The system includes data generating machine 102.1, an archival servicing system 104, accelerator node 110.1, accelerator node 110.2, and storage node 160.1. In some cases, the system also provisions the target storage node besides provisioning the accelerator nodes.

The data generating machine 102.1 generates and/or has data that is to be archived. In many cases, the data is on the order of many gigabytes to terabytes or more. The data generating machine has at least one memory element 230, e.g., for storing the data and instructions, and at least one processor 232 coupled to the at least one memory element that execute the instructions to carry out functionalities and provide module(s) described herein associated with the data generating machine 102.1. The data generating machine has an agent 112.1, which can reside locally to the data generating machine. The agent 112.1 can be configured to trigger a process to provision the accelerator nodes. The agent 112.1 can include a dispatcher that can interface with the archival servicing system 104. The dispatcher can, e.g., transmit HyperText Transfer Protocol (HTTP) GET and other REST-based requests to the archival servicing system 104.

The archival servicing system 104 can include at least one memory element 240, e.g., for storing information associated with archival jobs, accelerator nodes, and storage nodes, and instructions, and at least one processor 242 coupled to the at least one memory element that execute the instructions to carry out functionalities and provide module(s) described herein associated with the archival servicing system 104. The archival servicing system 104 can include an outpost 106 that interfaces with agent 112.1 of the data generating machine 102.1 and a provisioner 108 of the archival servicing system 104. The outpost 106 can receive requests from agents, e.g., agent 112.1, and coordinate with the provisioner 108 to provision accelerators.

The accelerator node 110.1 (and other accelerator nodes as well) can include at least one memory element 260, e.g., for storing data and instructions, and at least one processor 262 coupled to the at least one memory element that can execute the instructions to carry out functionalities and provide module(s) described herein associated with the accelerator node 110.1. The accelerator node 110.1 and 110.2 can have transfer managers 120.1 and 120.2 respectively for setting up of the accelerator nodes for an archival job. Accelerator nodes are enlisted via the archival servicing system 104 (e.g. the provisioner 108). Transfer managers can interface with the agent 112.1 on the data generating machine 102.1 to coordinate the provisioning of the accelerator nodes.

The (target) storage node 160.1 can include at least one memory element 270, e.g., for storing data and instructions, and at least one processor 272 coupled to the at least one memory element that can execute the instructions to carry out functionalities and provide module(s) described herein associated with the storage node 160.1. In some cases, the storage node 160.1 is a NAS filer having an available partition for archiving the data. The storage manager 170.1 implemented on the storage node 160.1 can interface with transfer managers 120.1 and 120.2 on accelerator nodes 110.1 and 110.2 to coordinate the provisioning of the storage node 160.1.

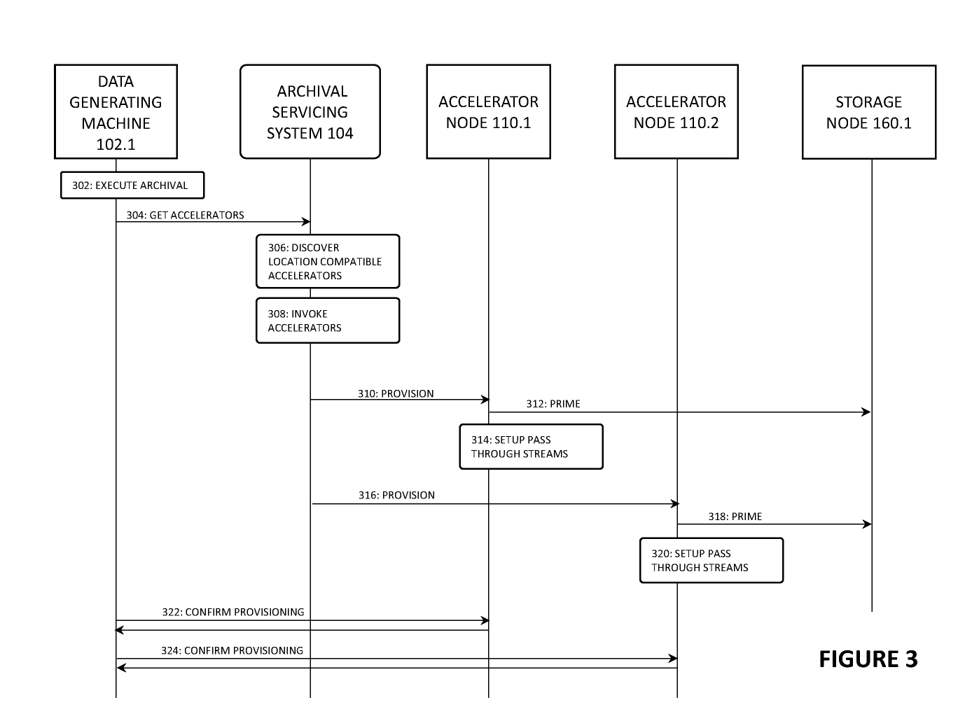

To illustrate the processes for provisioning accelerators and potentially the target storage node, the following passages describe an example for beginning an archival job to archive data generated by data generating machine 102.1, and setting up or provisioning the accelerator nodes 110.1 and 110.2 and storage node 160.1 using archival servicing system 104. An illustrative messaging diagram accompanying this example is shown in FIG. 3.

An archival job can have two different types. In one scenario, the data generating machine 102.1 can request a target storage node and requests=the archival servicing system 104 to provision both the target storage node and one or more accelerator nodes for that target storage node. In another scenario, the data generating machine 102.1 has a desired target storage node, and requests the archival servicing system 104 to provision one or more accelerator nodes for the desired storage node. Both scenarios are envisioned by the disclosure.

Suppose the data generating machine 102.1 has data to be archived, e.g., half a terabyte of build artifacts in a build tree that was created as a consequence of a compilation job. The archival job is to archive the data to a storage node. In some embodiments, the data is fragmented using a suitable scheme into fragments. The data generating machine 102 begins the archival job by requesting the agent 112.1 to execute the archival job (302 of FIG. 3). The agent 112.1 can be invoked by the data generating machine 102 to execute the archival job having the following parameters or inputs:
Information identifying source directory having the data to be copied;
Preferred number of parallel streams or transfers that can be supported by the data generating machine 102.1; and
(Optional) storage node to be used as target of the archival job.

The agent 112.1, such as the dispatcher of the agent 112.1, can send a request to the outpost 106 of archival servicing system 104 to request accelerator(s) to be provisioned (304 of FIG. 3), based on one or more parameters listed above. The request can be sent via a REST API, or any suitable interface.

The archival servicing system 104, such as the provisioner 108, can maintain a roster of active transfers and/or other usage statistics or metrics of available accelerator nodes and storage nodes. The information being maintained or monitored by the archival servicing system 104 helps to provision accelerator nodes and partitions on the storage nodes that are more or most suitable for the archival job. In some embodiments, the provisioner 108 receives one or more parameters of the request from the outpost 106, and queries the roster to find a suitable partition (e.g., a NAS partition if the storage node 160.1 is an NAS filer) that does not already have archival activity associated with it. If the desired storage node, e.g., a desired partition on the storage node, to be used is provided as one of the parameters, the provisioner 108 can validate to make sure a desired partition is not already busy, or determine whether an equivalent partition should instead to be used to prevent writing to an already busy disk. Herein, a target partition on a storage node and the storage node are referenced herein interchangeably as the target location of the archival job.

After the archival servicing system 104, e.g., the provisioner 108, has identified or determined the target storage node, e.g., target storage node 160.1 in this example, the provisioner 108 determines or discovers location compatible accelerator node(s) (306 of FIG. 3). In this example, for the sake of illustration, provisioner 108 determines that accelerator nodes 110.1 and 110.2 are the location compatible accelerator nodes for storage node 160.1. As described previously, the location of the accelerator node(s) to the storage node 160.1 affects the performance of the overall archival process. Preferably, the accelerator node(s) are co-located with the storage node 160.1 (shown to be in the same “location 1” in FIG. 2). The accelerator nodes are preferably in close proximity to the storage node 160.1, e.g., with little network distance or hops, or with low latency as a consequence of being on the same sub-network.

The provisioner 108 can invoke the location compatible accelerator nodes 110.1 and 110.2 to provision them and set them up for the archival job (308 of FIG. 3). An accelerator node can receive a provisioning request from an archival servicing system 104 (e.g., the provisioner 108) to invoke a process on the accelerator node for the transferring of one or more fragments from the data generating machine 102.1 to the storage node 160.1. Generally, the provisioner 108 would trigger a process on each of the accelerator nodes to be dedicated to the archival job. For instance, the provisioner 108 of archival servicing system 104 can send a request to provision accelerator node 110.1 (310 of FIG. 3), and send a request to provision accelerator node 110.2 (316 of FIG. 3) to trigger the process on each accelerator node. Generally speaking, the process for the archival job is triggered on the accelerator node to enable connections between the data generating machine 102.1 and the accelerator node, and between the accelerator node and the storage node, to be established or setup so that data transfers or operations can occur over those connections when the archival job is to be executed.

Part of the process for the archival job being triggered on accelerator node 110.1 is illustrated by the transfer manager 120.1 on accelerator node 110.1 coordinating with storage manager 170.1 to setup a connection between the accelerator node 110.1 and the storage node 160.1 (separate from the connection between the data generating machine 102.1 and the accelerator node 110.1) (312 of FIG. 3). In a similar fashion, part of the process for the archival job being triggered on accelerator node 110.2 is illustrated by the transfer manager 120.2 on accelerator node 110.2 coordinating with storage manager 170.1 to setup a connection between the accelerator node 110.2 and the storage node 160.1 (separate from the connection between the data generating machine 102.2 and the accelerator node 110.2) (318 of FIG. 3).

In some cases, the process for the archival job causes the accelerator node to open up one or more UNIX netcat (nc) processes for reading from and writing to a network connection between the data generating machine and the accelerator node. Depending on the number of fragments of the data that the accelerator node is responsible for transferring from the data generating machine to the storage node, a plurality of those UNIX nc processes may be opened up. Each UNIX nc process is further tied using a UNIX pipe to a UNIX dd utility for read and/or write files on the target storage node. These UNIX processes may be part of an accelerator node setting up pass through streams to enable fragments to be received and transmitted via the accelerator node during archival execution (314 and 320 of FIG. 3).

The accelerator nodes 110.1 and 110.2 may confirm to the agent 112.1 via provisioner 108 and outpost 106 of the archival servicing system 104 that the accelerator nodes have been provisioned. In some cases, the agent 112.1 may send a request to an accelerator node to confirm whether the accelerator node has been provisioned or primed properly (e.g., whether the UNIX pipes have been created and are ready for data transfer). For instance, the agent 112.1 may transmit a request to transfer manager 120.1 to confirm provisioning (322 of FIG. 3), and the agent 112.1 may transmit a request to transfer manager 120.1 to confirm provisioning (324 of FIG. 3). Accelerator nodes 110.1 and 110.2 may respond to the request by confirming to the data generating machine 120.1 that the accelerator node is provisioned to perform the transferring of one or more fragments to be received from the data generating machine 120.1 to the storage node.

Executing Archival

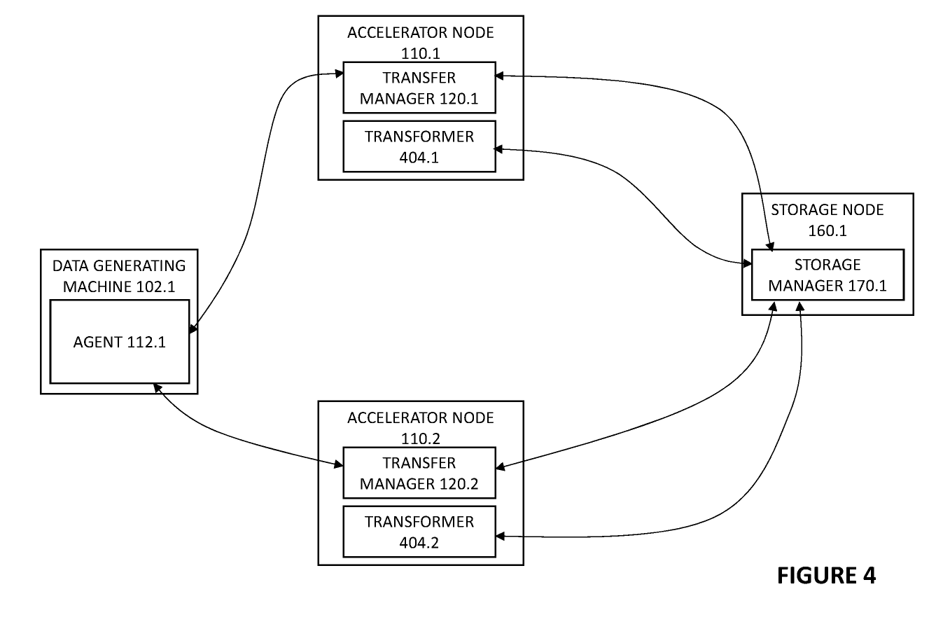

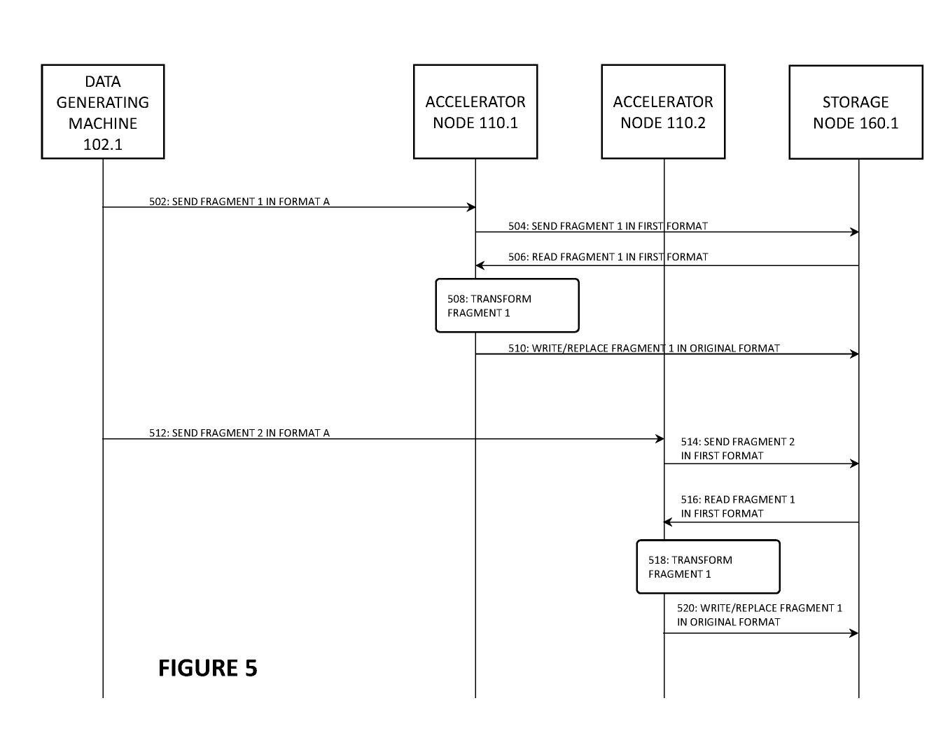

FIG. 4 shows a system for executing archival, according to some embodiments of the disclosure, e.g., after the accelerator nodes are provisioned in accordance with an example shown in FIG. 2. Executing an archival job means the fragments of the data are transmitted to the accelerator nodes and the accelerator nodes write the fragments to the storage node and performs loopback. The archival servicing system 104 is generally not involved in executing the archival job, thus is not shown in FIG. 4. To illustrate the processes for transferring data for archival, the following passages describe an example for executing or completing the archival job initiated by the processes shown in FIG. 2. An illustrative messaging diagram accompanying this example is shown in FIG. 5.

To continue with the archival job, agent 112.1 of data generating machine 102.1 can coordinate with a given transfer manager of an accelerator node to transfer multiple fragments as multiple streams of data concurrently using a low overhead protocol (provisioned by the processes illustrated by FIG. 3). A low overhead protocol suitable for this purpose can be used. For instance, agent 112.1 of the data generating machine 102.1 can transfer or write a first fragment of the data in a first format to the accelerator node 110.1 (502 of FIG. 5). In a similar fashion, agent 112.1 of the data generating machine 102.1 can transfer or write another fragment of the data in the first format to the accelerator node 110.2 (512 of FIG. 5). For simplicity, a single fragment is shown to be transferred to a given accelerator node, but it is envisioned by the disclosure that multiple fragments can be transferred to the given accelerator node or plurality of accelerator nodes concurrently. The first format can be a result of formatting the fragment into a transient format (comprising an archive format or a compression format), e.g., tar format, which is suitable for transferring the fragments over the low overhead protocol using, e.g., UNIX nc. Other suitable data persistence formats can be used, and encryption can be applied to the fragments as well. Generally speaking, the first format renders the data illegible or unusable until the data is transformed back into its original format. When transferring many fragments of the data from the data generating machine 102.1 to accelerator nodes, the agent 112.1 of data generating machine 102.1 can employ many non-reusable sockets to stream fragments directly to many accelerator nodes.

Using the pass through streams provisioned on accelerator node 110.1, transfer manager 120.1 of accelerator node 110.1 can transfer (send or write, e.g., using UNIX dd) the first fragment of the data in the first format received from the data generating machine 102.1 to storage node 160.1 (504 of FIG. 5), employing storage manager 170.1. The first fragment is thus written to target storage node 160.1 in the first format (e.g., to be persisted in the transient format). In a similar fashion, transfer manager 120.2 of accelerator node 110.2 can transfer (send or write, e.g., using UNIX dd) another fragment of the data in the first format received from the data generating machine 102.1 to storage node 160.1 (514 of FIG. 5), employing storage manager 170.1. The other fragment is thus written to target storage node 160.1 in the first format (e.g., to be persisted in the transient format). Many of these fragments in the first format are passed through to the storage node 160.1 via one of the accelerator nodes in this fashion. Accordingly, various multiple distributed co-located accelerator node are running multiple processes or threads tasked with transferring respective fragments as pass through to be persisted temporally on a location of the storage node 160.1.

Only after a fragment is transferred to the storage node 160.1 does the loopback activity begin on the fragment. Loopback for a fragment being transferred on one of the concurrent threads can involve the accelerator node reading back the fragment persisted on the storage node, transforming it to the original format and writing that as a replacement to the storage node. In this example, for loopback, transfer manager 120.1 of accelerator node 110.1 reads the first fragment in the first format from the storage node 160.1 after the transferring of the first fragment to the storage node is complete (506 of FIG. 5). A transformer 404.1 of accelerator node 110.1 transforms the first fragment in the first format to a second format, such as the original format of the first fragment (508 of FIG. 5). The transfer manager 120.1 of accelerator node 110.1 writes back the first fragment in the second format to the storage node (510 of FIG. 6). Furthermore, in a similar fashion, transfer manager 120.2 of accelerator node 110.2 reads the other fragment in the first format from the storage node 160.1 after the transferring of the other fragment to the storage node is complete (516 of FIG. 5). A transformer 404.2 of accelerator node 110.2 transforms the other fragment in the first format to a second format, such as the original format of the other fragment (518 of FIG. 5). The transfer manager 120.2 of accelerator node 110.2 writes back the first fragment in the second format to the storage node (520 of FIG. 6). In various embodiments, writing the fragment comprises erasing the fragment in the first format (e.g., transient format) and/or replacing the fragment in the first format (e.g., transient format) on the storage node with the fragment in the second format (e.g., original format).

The processes illustrated by FIG. 5 can be repeated in another concurrent process or thread on a given accelerator node for many other fragments. For instance, any one of the accelerator nodes can transfer a second fragment of the data in the first format received from the data generating machine 102.1 to the storage node 160.1, read the second fragment in the first format from the storage node after the transfer is complete, transform the second fragment in the first format to the second format, and write the second fragment in the second format back to the storage node 160.1. Generally speaking, the various loopback processes on a given accelerator node or across many accelerator nodes can occur concurrently. For instance 502, 504, 506, 508, and 510 of FIG. 5 can occur in parallel with 512, 514, 516, 518, and 520.

Advantages

The examples described herein illustrates methods, systems, and apparatuses for fast archival with loopback. Archival can be provided as a service, where the service can discover and provision distributed accelerator nodes which are co-located to target storage node. The accelerator nodes are used directly to transfer fragments of data from the data generating machine to the accelerator nodes using a low overhead protocol. In some cases, the archival servicing system can additionally provide the capability to detect and limit transfer to busy disks or devices of target storage node and remedy by re-directing to equivalent storage devices instead. The distributed accelerator nodes concurrently pass through received fragments to the target storage node in a transfer compatible transient format. The accelerator nodes also perform a loopback from the storage node to the accelerator node to transform the fragments to the original data format. This extensible loopback can provide for plugging in additional data stream transformations while putting minimal overhead on the primary data transfer pipeline. Overall, the fast archival system with loopback frees up the data generating machine faster than other archival tools. By decoupling transformation and data transmission, long transformation activities would not hold the data transmission to ransom. This further prevents flooding of memory in the accelerator node from being backed up because of long running transformations. In other words, transformation processes can even be performed at other nodes since the transformation process has been decoupled from the data transmission.

In some cases, parallelism of the processes can further improve the speed of archival. For instance, some systems may have B number of concurrent agents on the data generating machine packaging data for transfer, X number of concurrent processes for transferring fragments from the data generating machine to accelerator, while Y number of processes working through transfers from accelerator node to storage node, while Z number of processes conducting a read of the transient format based fragments from the storage node, while A number of processes executing transformation and writing of data in the original format back onto the storage node.

In some cases, the speed of writing to a storage node from remote NFS location over an unreliable network is not as good as using a low overhead protocol transfer from a data generating machine to an accelerator node co-located to the storage node which in turn then writes to the storage node over multiple connections.

In some cases, having real-time information of all the multiple transfers at any given time, allows for detection of pre-occupied/busy storage nodes or disks/devices on the storage node and providing equivalent end target instead for better archival speed.

In some cases, the fast archival system with loopback handles fail over scenarios better. Failures can occur at various stages of archival. The architecture of the fast archival system allows for better handling of failure scenarios. One example of a possible failure scenario is a failure of a transmission from data generating machine to an accelerator node. Since the large transfer of data is broken up into multiple different fragments, only the failed fragment will require to be re-transmitted. Another example of a possible failure scenario is a failure of the archival servicing system. Even if the archival servicing system fails, archival in flight (which does not require the archival servicing system's participation) can continue uninhibited. Another example of a possible failure scenario is a failure at the transformation stage. In case the transformation of a fragment fails, retransmission from the data generating machine 102.1 will not be required.

One or more advantages mentioned herein does not in any way suggest that any one of the embodiments necessarily provides all the described advantages or that all the embodiments of the invention necessarily provide any one of the described advantages.

### EXAMPLES, VARIATIONS AND IMPLEMENTATIONS

Example 1 is a method for accelerating archival of data with loopback, comprising: transferring at an accelerator node a first fragment of the data in a first format received from a data generating machine to a storage node; reading the first fragment in the first format by the accelerator node from the storage node after the transferring is complete; transforming by the accelerator node the first fragment in the first format to a second format; and writing the first fragment in the second format by the accelerator node to the storage node.

In Example 2, Example 1 can further include writing the first fragment comprising replacing the first fragment in the first format on the storage node with the first fragment in the second format.

In Example 3, Example 1 or 2 can further include receiving a provisioning request from an archival servicing system to invoke a process on the accelerator node for the transferring of the first fragment from the data generating machine to the storage node.

In Example 4, any one of the above Examples can further include the first format comprising an archive format and the second format being an original format of the data.

In Example 5, any one of the above Examples can further include the accelerator node being co-located with the storage node.

In Example 6, any one of the above Examples can further include confirming by the accelerator node to the data generating machine that the accelerator node is provisioned to perform the transferring of the first fragment to the storage node.

In Example 7, any one of the above Examples can further include: transferring at the accelerator node a second fragment of the data in the first format received from the data generating machine to the storage node; reading the second fragment in the first format by the accelerator node from the storage node after the transfer is complete; transforming by the accelerator node the second fragment in the first format to the second format; and writing the second fragment in the second format by the accelerator node to the storage node.

Example 8 is an accelerator node for accelerating archival of data with loopback, comprising: at least one memory element; at least one processor coupled to the at least one memory element; a transfer manager that when executed by the at least one processor is configured to transfer a first fragment of the data in a first format received from a data generating machine to a storage node, and read the first fragment in the first format from the storage node after the transferring is complete; and a transformer that when executed by the at least one processor is configured to transform the first fragment in the first format to a second format; wherein the transfer manager that when executed by the at least one processor is further configured to write the first fragment in the second format to the storage node.

In Example 9, Example 8 can further include: writing the first fragment comprising replacing the first fragment in the first format on the storage node with the first fragment in the second format.

In Example 10, Example 8 or 9 can further include the transfer manager that when executed by the at least one processor being further configured to receive a provisioning request from an archival servicing system to invoke a process to be executed by the at least one processor for the transferring of the first fragment from the data generating machine to the storage node.

In Example 11, any one of Examples 8-10 can further include the first format comprising an archive format and the second format being an original format of the data.

In Example 12, any one of Examples 8-11 can further include the accelerator node being co-located with the storage node.

In Example 13, any one of Examples 8-12 can further include the transfer manager that when executed by the at least one processor being further configured to confirm to the data generating machine that the accelerator node is provisioned to perform the transferring of the first fragment to the storage node.

In Example 14, any one of Examples 8-13 can further include the transfer manager that when executed by the at least one processor being further configured to transfer a second fragment of the data in the first format received from the data generating machine to the storage node, and read the second fragment in the first format from the storage node after the transfer is complete; the transformer that when executed by the at least one processor being further configured to transform the second fragment in the first format to the second format; and the transfer manager that when executed by the at least one processor being further configured to write the second fragment in the second format by the accelerator node to the storage node.

Example 15 is a computer-readable non-transitory medium comprising one or more instructions, for accelerating archival of data with loopback, that when executed on a processor configure the processor to perform one or more operations comprising: transferring at an accelerator node a first fragment of the data in a first format received from a data generating machine to a storage node; reading the first fragment in the first format by the accelerator node from the storage node after the transferring is complete; transforming by the accelerator node the first fragment in the first format to a second format; and writing the first fragment in the second format by the accelerator node to the storage node.

In Example 16, Example 15 can further include writing the first fragment comprising replacing the first fragment in the first format on the storage node with the first fragment in the second format.

In Example 17, Example 15 or 16 can further include the operations further comprising receiving a provisioning request from an archival servicing system to invoke a process on the accelerator node for the transferring of the first fragment from the data generating machine to the storage node.

In Example 18, any one of Examples 15-17 can further include the first format comprising an archive format and the second format being an original format of the data.

In Example 19, any one of Examples 15-18 can further include the accelerator node being co-located with the storage node.

In Example 20, any one of Examples 15-19 can further include the operations further comprising: confirming by the accelerator node to the data generating machine that the accelerator node is provisioned to perform the transferring of the first fragment to the storage node.

Example 21 is an apparatus for accelerating archival of data with loopback, comprising: means for transferring at an accelerator node a first fragment of the data in a first format received from a data generating machine to a storage node; means for reading the first fragment in the first format by the accelerator node from the storage node after the transferring is complete; means for transforming by the accelerator node the first fragment in the first format to a second format; and means for writing the first fragment in the second format by the accelerator node to the storage node.

In Example 22, Example 21 can further include means for carrying out any one of the methods described in Examples 2-7.

One data generating machine, one archival servicing system, two accelerator nodes, and one storage node are shown in examples seen in FIGS. 2 and 4; other systems envisioned by the disclosure can have the same or different number of said data generating machines, archival servicing system, accelerator nodes, and storage nodes (which can be implemented in a similar fashion as ones described herein).

Within the context of the disclosure, a network used herein allowing various components described herein (as a network element) to communicate with each other represents a series of points, nodes, or network elements of interconnected communication paths for receiving and transmitting packets of information that propagate through a communication system. A network offers communicative interface between sources and/or hosts, and may be any local area network (LAN), wireless local area network (WLAN), metropolitan area network (MAN), Intranet, Extranet, Internet, WAN, virtual private network (VPN), or any other appropriate architecture or system that facilitates communications in a network environment depending on the network topology. A network can comprise any number of hardware or software elements coupled to (and in communication with) each other through a communications medium.

In one particular instance, the architecture of the present disclosure can be associated with a service provider deployment. In other examples, the architecture of the present disclosure would be equally applicable to other communication environments, such as an enterprise wide area network (WAN) deployment. The architecture of the present disclosure may include a configuration capable of transmission control protocol/internet protocol (TCP/IP) communications for the transmission and/or reception of packets in a network.

As used herein in this Specification, the term ‘network element’ is meant to encompass any of the aforementioned elements, as well as servers (physical or virtually implemented on physical hardware), machines (physical or virtually implemented on physical hardware), end user devices, routers, switches, cable boxes, gateways, bridges, loadbalancers, firewalls, inline service nodes, proxies, processors, modules, or any other suitable device, component, element, proprietary appliance, or object operable to exchange, receive, and transmit information in a network environment. These network elements may include any suitable hardware, software, components, modules, interfaces, or objects that facilitate the fast archival operations thereof. This may be inclusive of appropriate algorithms and communication protocols that allow for the effective exchange of data or information.

In one implementation, data generating machines, archival servicing systems, accelerator nodes, and storage nodes described herein may include software to achieve (or to foster) the functions discussed herein for fast archival with loopback where the software is executed on one or more processors to carry out the functions. This could include the implementation of instances of modules such as agents, outposts, provisioners, transfer managers, transformers, and storage managers and/or any other suitable element that would foster the activities discussed herein. Additionally, each of these elements can have an internal structure (e.g., a processor, a memory element, etc.) to facilitate some of the operations described herein. In other embodiments, these functions for fast archival with loopback may be executed externally to these elements, or included in some other network element to achieve the intended functionality. Alternatively, data generating machines, archival servicing systems, accelerator nodes, and storage nodes may include software (or reciprocating software) that can coordinate with other network elements in order to achieve the fast archival functions described herein. In still other embodiments, one or several devices may include any suitable algorithms, hardware, software, components, modules, interfaces, or objects that facilitate the operations thereof.

In certain example implementations, the fast archival functions outlined herein may be implemented by logic encoded in one or more non-transitory, tangible media (e.g., embedded logic provided in an application specific integrated circuit [ASIC], digital signal processor [DSP] instructions, software [potentially inclusive of object code and source code] to be executed by one or more processors, or other similar machine, etc.). In some of these instances, one or more memory elements can store data used for the operations described herein. This includes the memory element being able to store instructions (e.g., software, code, etc.) that are executed to carry out the activities described in this Specification. The memory element is further configured to store databases such as the roster of active transfers disclosed herein. The processor can execute any type of instructions associated with the data to achieve the operations detailed herein in this Specification. In one example, the processor could transform an element or an article (e.g., data) from one state or thing to another state or thing. In another example, the activities outlined herein may be implemented with fixed logic or programmable logic (e.g., software/computer instructions executed by the processor) and the elements identified herein could be some type of a programmable processor, programmable digital logic (e.g., a field programmable gate array [FPGA], an erasable programmable read only memory (EPROM), an electrically erasable programmable ROM (EEPROM)) or an ASIC that includes digital logic, software, code, electronic instructions, or any suitable combination thereof.

Any of these elements (e.g., the network elements, etc.) can include memory elements for storing information to be used in achieving fast archival with loopback, as outlined herein. Additionally, each of these devices may include a processor that can execute software or an algorithm to perform the activities as discussed in this Specification. These devices may further keep information in any suitable memory element [random access memory (RAM), ROM, EPROM, EEPROM, ASIC, etc.], software, hardware, or in any other suitable component, device, element, or object where appropriate and based on particular needs. Any of the memory items discussed herein should be construed as being encompassed within the broad term ‘memory element.’ Similarly, any of the potential processing elements, modules, and machines described in this Specification should be construed as being encompassed within the broad term ‘processor.’ Each of the network elements can also include suitable interfaces for receiving, transmitting, and/or otherwise communicating data or information in a network environment.

Additionally, it should be noted that with the examples provided above, interaction may be described in terms of two, three, or four network elements. However, this has been done for purposes of clarity and example only. In certain cases, it may be easier to describe one or more of the functionalities of a given set of flows by only referencing a limited number of network elements. It should be appreciated that the systems described herein are readily scalable and, further, can accommodate a large number of components, as well as more complicated/sophisticated arrangements and configurations. Accordingly, the examples provided should not limit the scope or inhibit the broad techniques of fast archival with loopback, as potentially applied to a myriad of other architectures.

It is also important to note that the processes in FIGS. 3 and 5 illustrate only some of the possible scenarios that may be executed by, or within, the data generating machines, archival servicing systems, accelerator nodes, and storage nodes described herein. Some of these steps may be deleted or removed where appropriate, or these steps may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by data generating machines, archival servicing systems, accelerator nodes, and storage nodes in that any suitable arrangements, chronologies, configurations, and timing mechanisms may be provided without departing from the teachings of the present disclosure.

It should also be noted that many of the previous discussions may imply a single client-server relationship. In reality, there is a multitude of servers in the delivery tier in certain implementations of the present disclosure. Moreover, the present disclosure can readily be extended to apply to intervening servers further upstream in the architecture, though this is not necessarily correlated to the ‘m’ clients that are passing through the ‘n’ servers. Any such permutations, scaling, and configurations are clearly within the broad scope of the present disclosure.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A method for accelerating archival of data with loopback, comprising:
transferring at an accelerator node a first fragment of the data in a first format received from a data generating machine to a storage node;
reading the first fragment in the first format by the accelerator node from the storage node after the transferring is complete;
transforming by the accelerator node the first fragment in the first format to a second format; and
writing the first fragment in the second format by the accelerator node to the storage node.

2. The method of claim 1, wherein writing the first fragment comprises replacing the first fragment in the first format on the storage node with the first fragment in the second format.

3. The method of claim 1, further comprising receiving a provisioning request from an archival servicing system to invoke a process on the accelerator node for the transferring of the first fragment from the data generating machine to the storage node.

4. The method of claim 1, wherein the first format comprises an archive format and the second format is an original format of the data.

5. The method of claim 1, wherein the accelerator node is co-located with the storage node.

6. The method of claim 1, further comprising:
confirming by the accelerator node to the data generating machine that the accelerator node is provisioned to perform the transferring of the first fragment to the storage node.

7. The method of claim 1, further comprising:
transferring at the accelerator node a second fragment of the data in the first format received from the data generating machine to the storage node;
reading the second fragment in the first format by the accelerator node from the storage node after the transfer is complete;
transforming by the accelerator node the second fragment in the first format to the second format; and
writing the second fragment in the second format by the accelerator node to the storage node.

8. An accelerator node for accelerating archival of data with loopback, comprising:
at least one memory element;
at least one processor coupled to the at least one memory element;
a transfer manager that when executed by the at least one processor is configured to transfer a first fragment of the data in a first format received from a data generating machine to a storage node, and read the first fragment in the first format from the storage node after the transferring is complete; and
a transformer that when executed by the at least one processor is configured to transform the first fragment in the first format to a second format;
wherein the transfer manager that when executed by the at least one processor is further configured to write the first fragment in the second format to the storage node.

9. The accelerator node of claim 8, wherein writing the first fragment comprises replacing the first fragment in the first format on the storage node with the first fragment in the second format.

10. The accelerator node of claim 8, wherein the transfer manager that when executed by the at least one processor is further configured to receive a provisioning request from an archival servicing system to invoke a process to be executed by the at least one processor for the transferring of the first fragment from the data generating machine to the storage node.

11. The accelerator node of claim 8, wherein the first format comprises an archive format and the second format is an original format of the data.

12. The accelerator node of claim 8, wherein the accelerator node is co-located with the storage node.

13. The accelerator node of claim 8, wherein the transfer manager that when executed by the at least one processor is further configured to confirm to the data generating machine that the accelerator node is provisioned to perform the transferring of the first fragment to the storage node.

14. The accelerator node of claim 8, wherein:
the transfer manager that when executed by the at least one processor is further configured to transfer a second fragment of the data in the first format received from the data generating machine to the storage node, and read the second fragment in the first format from the storage node after the transfer is complete;
the transformer that when executed by the at least one processor is further configured to transform the second fragment in the first format to the second format; and
the transfer manager that when executed by the at least one processor is further configured to write the second fragment in the second format by the accelerator node to the storage node.

15. A computer-readable non-transitory medium comprising one or more instructions, for accelerating archival of data with loopback, that when executed on a processor configure the processor to perform one or more operations comprising:
transferring at an accelerator node a first fragment of the data in a first format received from a data generating machine to a storage node;
reading the first fragment in the first format by the accelerator node from the storage node after the transferring is complete;
transforming by the accelerator node the first fragment in the first format to a second format; and
writing the first fragment in the second format by the accelerator node to the storage node.

16. The computer-readable non-transitory medium of claim 15, wherein writing the first fragment comprises replacing the first fragment in the first format on the storage node with the first fragment in the second format.

17. The computer-readable non-transitory medium of claim 15, wherein the operations further comprise receiving a provisioning request from an archival servicing system to invoke a process on the accelerator node for the transferring of the first fragment from the data generating machine to the storage node.

18. The computer-readable non-transitory medium of claim 15, wherein the first format comprises an archive format and the second format is an original format of the data.

19. The computer-readable non-transitory medium of claim 15, wherein the accelerator node is co-located with the storage node.

20. The computer-readable non-transitory medium of claim 15, wherein the operations further comprise:
confirming by the accelerator node to the data generating machine that the accelerator node is provisioned to perform the transferring of the first fragment to the storage node.
